(19) United States
(12) Patent Application Publication
(10) Pub. No.: US 2018/0359245 A1
(43) Pub. Date: Dec. 13, 2018

(54) Communication Method and Apparatus

(71) Applicant: Alibaba Group Holding Limited, Grand Cayman (KY)

(72) Inventors: Lili Zhang, Zhejiang (CN); Hang Chen, Zhejiang (CN)

(21) Appl. No.: 16/104,595

(22) Filed: Aug. 17, 2018

Related U.S. Application Data
(63) Continuation of application No. PCT/CN2017/072879, filed on Feb. 4, 2017.

(30) Foreign Application Priority Data
Feb. 17, 2016 (CN) 201610090043.2

(51) Int. Cl. H04L 29/06

(52) U.S. Cl. CPC H04L 63/0861; H04L 63/0428

(57) ABSTRACT

Example embodiments of the present disclosure provide a communication method and apparatus. The communication method may include: a present end device initiating a user identity authentication request to a counterpart end device; the present end device, based on response information received by the present end device, determining whether a communicating counterparty passes identity authentication, the response information being transmitted from the counterpart end device to the present end device directly or being generated by a server based on return information originating from the counterpart end device; when the communicating counterparty passes identity authentication, the present end device completing a communication process between a present communicating party and the communicating counterparty. Example embodiments of the present disclosure may enhance communication security, and protect the interests of communicating parties.

### CROSS REFERENCE TO RELATED PATENT APPLICATIONS

This application claims priority to and is a continuation of PCT Patent Application No. PCT/CN2017/072879, filed on Feb. 4, 2017, which claims priority to Chinese Patent Application No. 201610090043.2, filed on Feb. 17, 2016 and entitled “COMMUNICATION METHOD AND APPARATUS”, which are incorporated herein by reference in their entirety.

### TECHNICAL FIELD

The present disclosure relates to the field of communications, and, more particularly, to communication methods and apparatuses.

### BACKGROUND

With regard to sensitive content, each communicating party needs to confirm the security of a communication environment, to avoid exposure of sensitive content. In related technology, if communication information is encrypted, then even if the communication information is exposed, sensitive content therein may not be readily viewed and thus is protected.

However, in situations such as loss of an electronic device or exposure of an account password, an illicit user may impersonate a user and thereby obtain sensitive content from other users, causing serious harm.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

Example embodiments of the present disclosure provide communication methods and apparatuses, which may enhance communication security, and protect the interests of communicating parties.

To solve the above technical problem, the present disclosure provides technical solutions as follows.

An aspect of the present disclosure provides a communication method, including:

A present end device initiating a user identity authentication request to a counterpart end device;

The present end device, based on response information received by the present end device, determining whether a communicating counterparty passes identity authentication, the response information being transmitted from the counterpart end device to the present end device directly or being generated by a server based on return information originating from the counterpart end device;

When the communicating counterparty passes identity authentication, the present end device completing a communication process between a present communicating party and the communicating counterparty.

An aspect of the present disclosure provides a communication method, including:

A server transmitting a user identity authentication request initiated by a first end device to a second end device;

The server generating, based on return information of the second end device, response information for the user identity authentication request;

The server transmitting the return information to the first end device, and when the first end device determines that a second communicating party passes identity authentication, completing a communication process between a first communicating party and the second communicating party.

An aspect of the present disclosure provides a communication apparatus, including:

One or more processors;

Memory;

A request unit stored in the memory and executable by the one or more processors to cause a present end device to initiate an identification authentication request to a counterpart end device;

An authentication unit stored in the memory and executable by the one or more processors to cause the present end device to, based on received response information, determine whether a communicating counterparty passes identity authentication, the response information being transmitted from the counterpart end device to the present end device directly or being generated by a server based on return information originating from the counterpart end device;

A communication unit stored in the memory and executable by the one or more processors to cause the present end device to, when the communicating counterparty passes identity authentication, complete a communication process between a present communicating party and the communicating counterparty.

An aspect of the present disclosure provides a communication apparatus, comprising:

One or more processors;

Memory;

A first transmission unit stored in the memory and executable by the one or more processors to cause the server to transmit a user identity authentication request initiated by a first end device to a second end device;

A generation unit stored in the memory and executable by the one or more processors to cause the server to generate, based on return information of the second end device, response information for the user identity authentication request;

A second transmission unit stored in the memory and executable by the one or more processors to cause the server to transmit the return information to the first end device, and when the first end device determines that a second communicating party passes identity authentication, completing a communication process between a first communicating party and the second communicating party.

As shown by the above technical solutions, the example embodiments of the present disclosure, through authenticating the user identity of a communicating counterparty, may ensure that the communicating counterparty is an authorized user, preventing the impersonation of the user by an illicit user in the event that an electronic device is lost, an account password is exposed, and the like. Thereby communication security is enhanced, and the interests of communicating parties are protected.

### BRIEF DESCRIPTION OF THE DRAWINGS

To describe the technical solutions in the example embodiments of the present disclosure more clearly, the following briefly introduces the accompanying drawings describing the example embodiments. It will be apparent that the accompanying drawings described in the following merely represent some example embodiments described in the present disclosure, and those of ordinary skill in the art may still derive other drawings from these accompanying drawings without creative efforts.

FIG. 1 is a flowchart of a method of communication by an authentication-initiating party according to an example embodiment provided by the present disclosure.

FIG. 2 is a flowchart of a method of communication by an authentication-responding party according to an example embodiment provided by the present disclosure.

FIG. 3 is a flowchart of a method of communication by a server according to an example embodiment provided by the present disclosure.

FIG. 4 is a flowchart of a method of communication by adding identity authentication according to an example embodiment provided by the present disclosure.

FIGS. 5A-5E are views of a communication interface according to an example embodiment of the present disclosure.

FIG. 6 is a flowchart of another method of communication by adding identity authentication according to an example embodiment provided by the present disclosure.

FIG. 7 is a schematic of an electronic device of an authentication-initiating party according to an example embodiment of the present disclosure.

FIG. 8 is a block diagram of an electronic device of an authentication-initiating party according to an example embodiment of the present disclosure.

FIG. 9 is a schematic of an electronic device of an authentication-responding party according to an example embodiment of the present disclosure.

FIG. 10 is a block diagram of an electronic device of an authentication-responding party according to an example embodiment of the present disclosure.

FIG. 11 is a schematic of an electronic device of a server according to an example embodiment of the present disclosure.

FIG. 12 is a block diagram of an electronic device of a server according to an example embodiment of the present disclosure.

### DETAILED DESCRIPTION

In order to enable those skilled in the art to better understand the technical solutions in the present disclosure, the technical solutions in the example embodiments of the present disclosure will be described clearly and completely through the accompanying drawings in the example embodiments of the present disclosure. It will be apparent that the described example embodiments represent merely some of example embodiments of the present disclosure, rather than all the example embodiments. Based on the example embodiments of the present disclosure, all other example embodiments derived by those of ordinary skill in the art without any creative effort shall fall within the protection scope of the present disclosure.

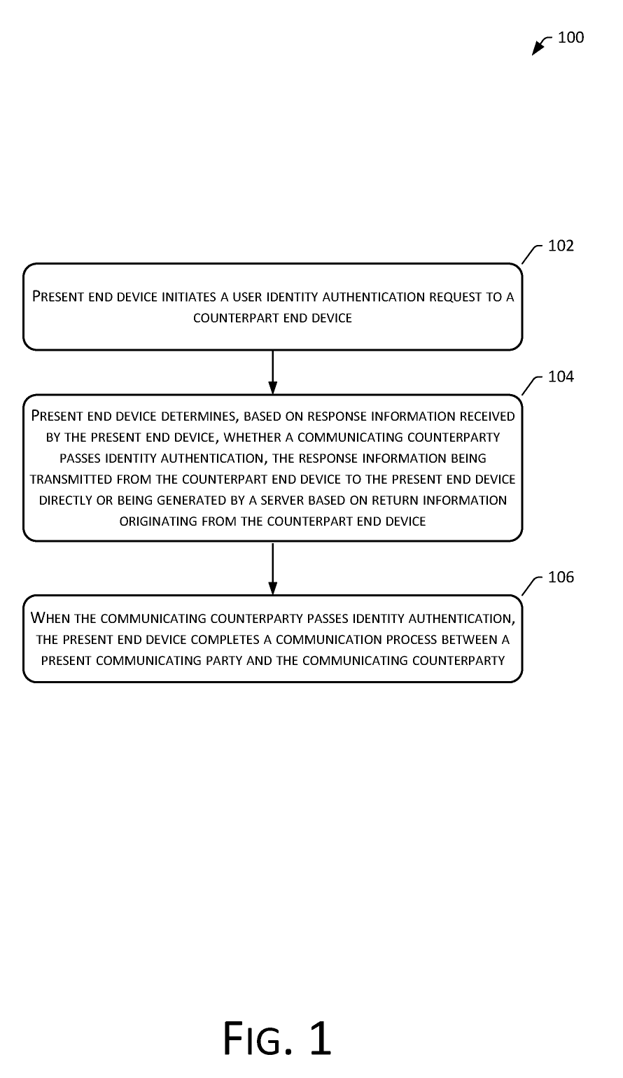

FIG. 1 is a flowchart of a method 100 of communication by an authentication-initiating party according to an example embodiment provided by the present disclosure. As illustrated by FIG. 1, the method as applied to an electronic device of the authentication-initiating party may include the following steps:

In step 102, a present end device initiates a user identity authentication request to a counterparty end device.

In step 104, the present end device determines, based on response information received by the present end device, whether a communicating counterparty passes identity authentication, the response information being transmitted from the counterpart end device to the present end device directly or being generated by a server based on return information originating from the counterpart end device.

In step 106, when the communicating counterparty passes identity authentication, the present end device completes a communication process between a present communicating party and the communicating counterparty.

According to example embodiments as above, an identity authentication process between the present end device and the counterpart end device may be directly completed between the present end device and the counterpart end device, such as by end-to-end communication between the present end device and the counterpart end device, such that the present end device may directly receive return information transmitted by the counterpart end device, without a need for a server intermediary; or, a server may assist in the identity authentication process between the present end device and the counterpart end device, such that the present end device may receive response information generated by the server based on return information of the counterpart end device.

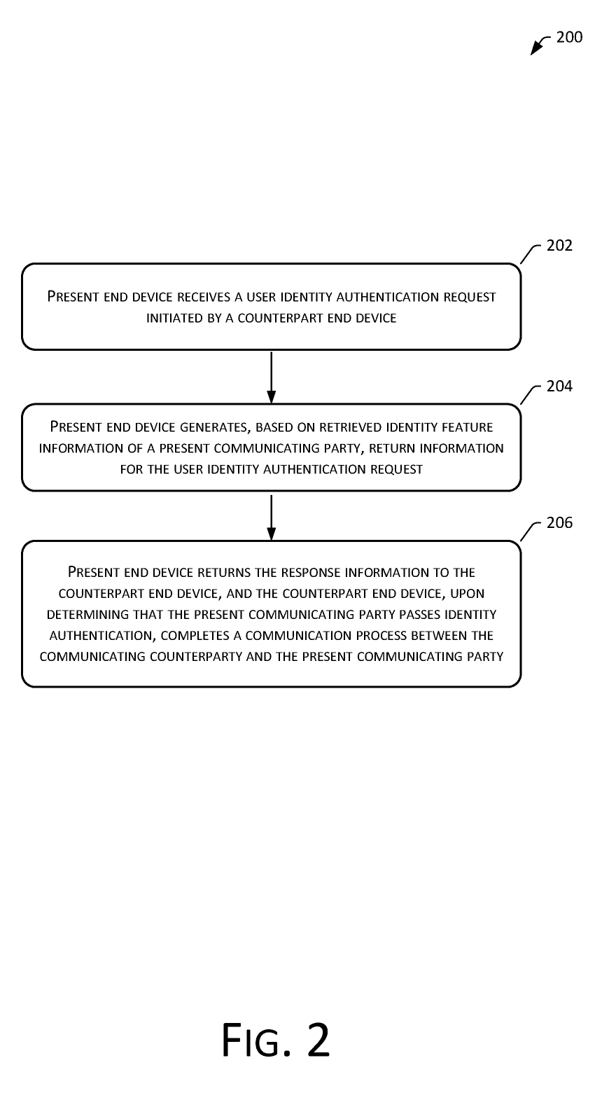

Correspondingly, FIG. 2 is a flowchart of a method 200 of communication by an authentication-responding party according to an example embodiment provided by the present disclosure. As illustrated by FIG. 2, the method as applied to an electronic device of the authentication-responding party may include the following steps:

In step 202, a present end device receives a user identity authentication request initiated by a counterpart end device.

In step 204, the present end device generates, based on retrieved identity feature information of a present communicating party, return information for the user identity authentication request.

In step 206, the present end device returns the response information to the counterpart end device, and the counterpart end device, upon determining that the present communicating party passes identity authentication, completes a communication process between the communicating counterparty and the present communicating party.

It will be appreciated that example embodiments illustrated by FIG. 1 are described from the perspective of an “authentication-initiating party,” and thus the “present end device” is an electronic device utilized by the “authentication-initiating party,” and the “counterpart end device” is an electronic device utilized by an “authentication-responding party”; while example embodiments illustrated by FIG. 2 are described from the perspective of an “authentication-responding party,” and thus the “present end device” is an electronic device utilized by the “authentication-responding party,” and the “counterpart end device” is an electronic device utilized by an “authentication-initiating party.”

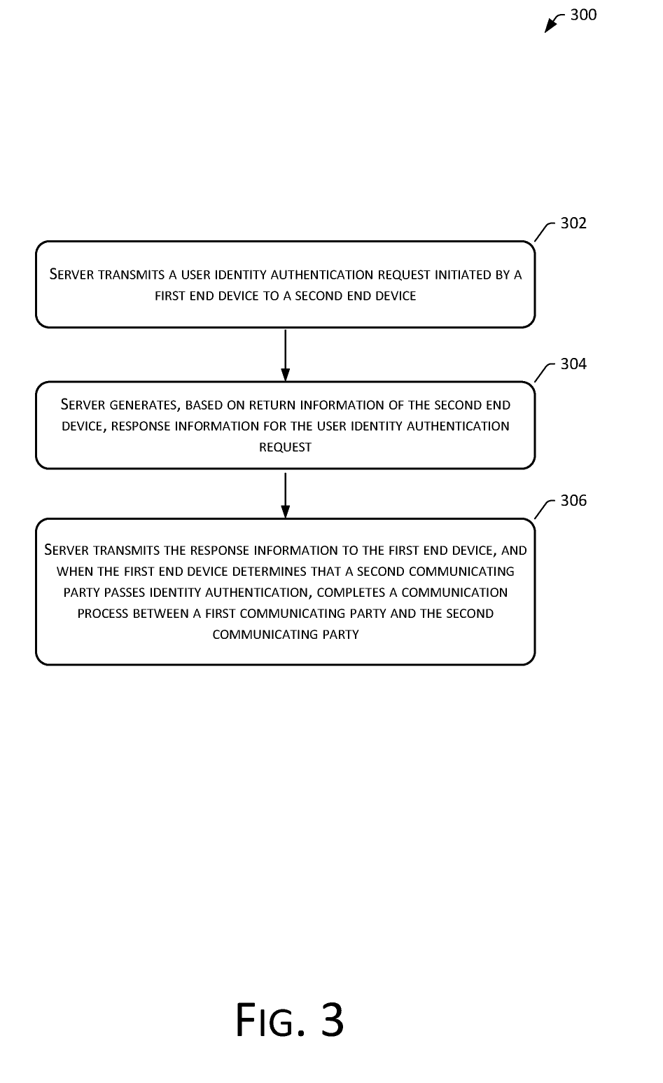

Correspondingly, where the complementary functionality of the server is concerned, FIG. 3 is a flowchart of a method 300 of communication by a server according to an example embodiment provided by the present disclosure. As illustrated by FIG. 3, the method as applied to a server may include the following steps:

In step 302, the server transmits a user identity authentication request initiated by a first end device to a second end device.

In step 304, the server generates, based on return information of the second end device, response information for the user identity authentication request.

In step 306, the server transmits the response information to the first end device, and when the first end device determines that a second communicating party passes identity authentication, completes a communication process between a first communicating party and the second communicating party.

By the above-mentioned technical solutions, the present disclosure, through authenticating the user identity of a communicating counterparty, may verify that the communicating counterparty is an authorized user, preventing an illicit user impersonating the authorized user in the event of electronic device loss, account password exposure, and the like, thus helping to enhance communication security and protect the interests of communicating parties.

For ease of understanding, the below combines the parties participating in a communication process and an interaction process therebetween, to describe the technical solutions of the present disclosure in detail.

1. Direct Communication

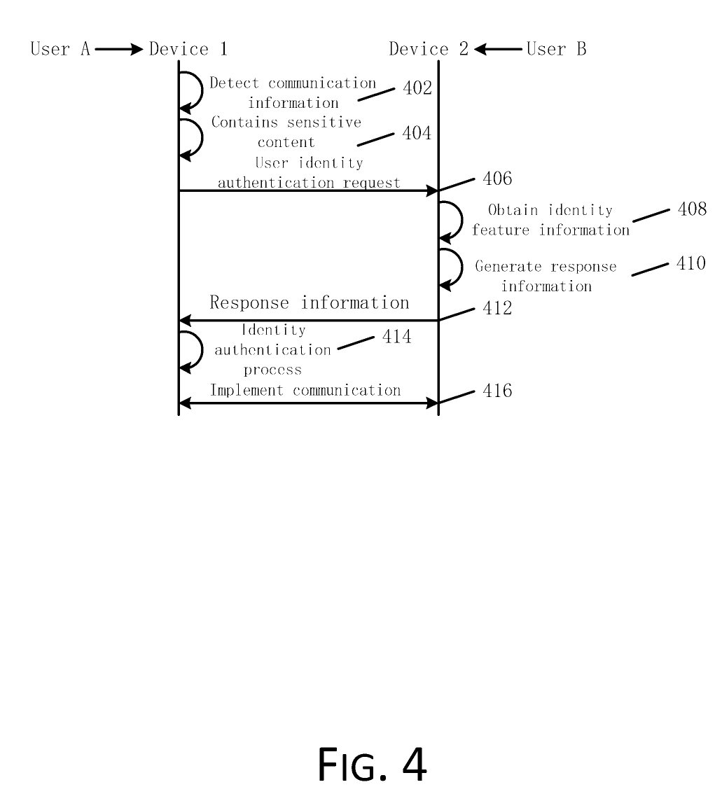

FIG. 4 is a flowchart of a method of communication by adding identity authentication according to an example embodiment provided by the present disclosure. As illustrated by FIG. 4, suppose that user A utilizes (such as by logging into a corresponding registered account) device 1, user B utilizes (such as by logging into a corresponding registered account) device 2, such that user A and user B through device 1 and device 2 implement direct communication, and in the course of the communication process implement identity authentication; for example, when user A initiates authentication and user B responds to authentication, the method may include the following steps:

In step 402, device 1 detects communication information.

In step 404, device 1 determines whether sensitive content is contained in the communication information, and proceeds to step 406 if so contained.

In step 406, device 1 transmits a user identity authentication request to device 2.

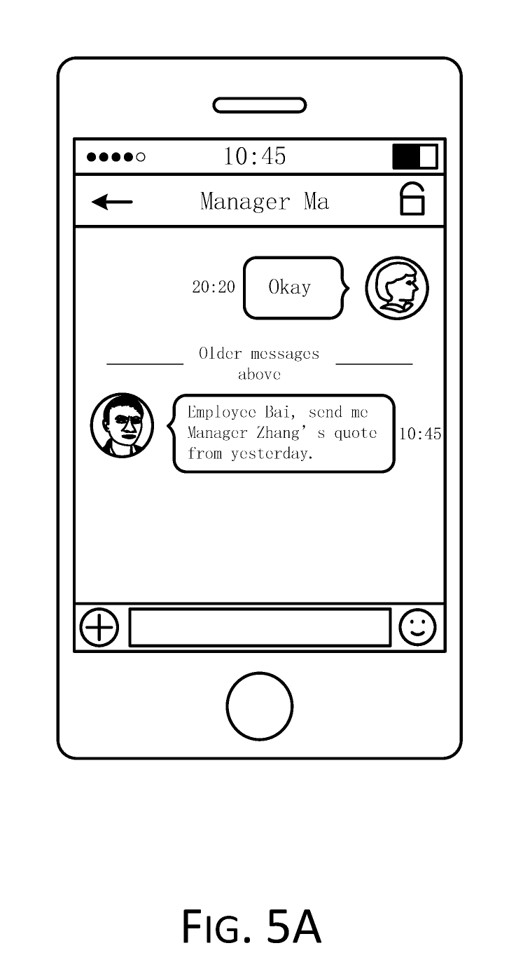

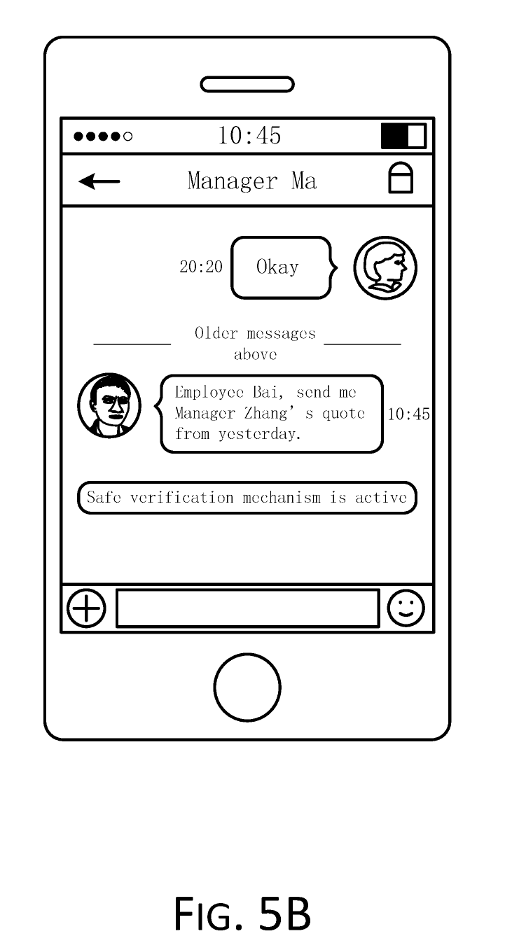

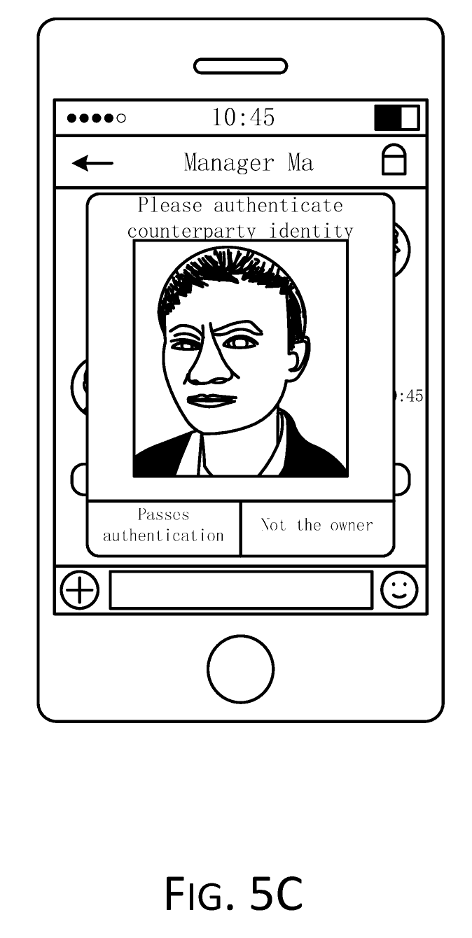

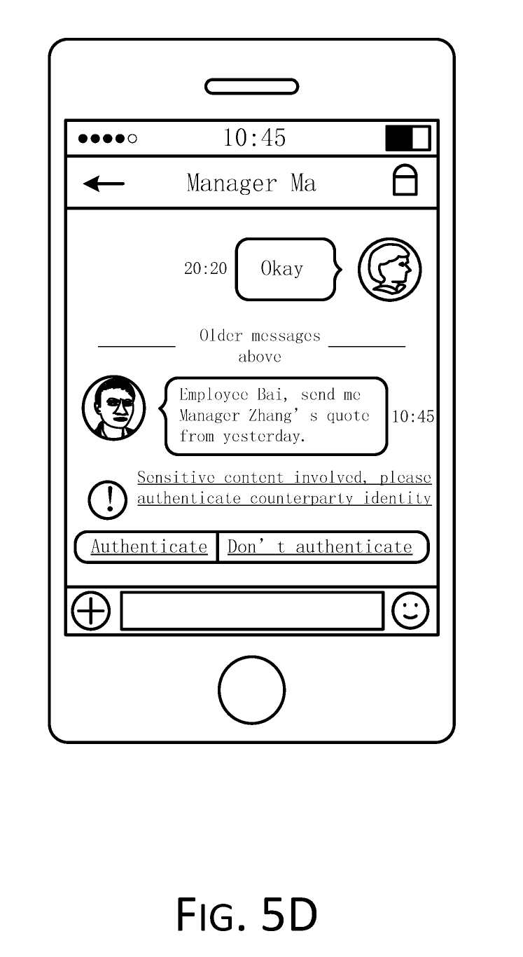

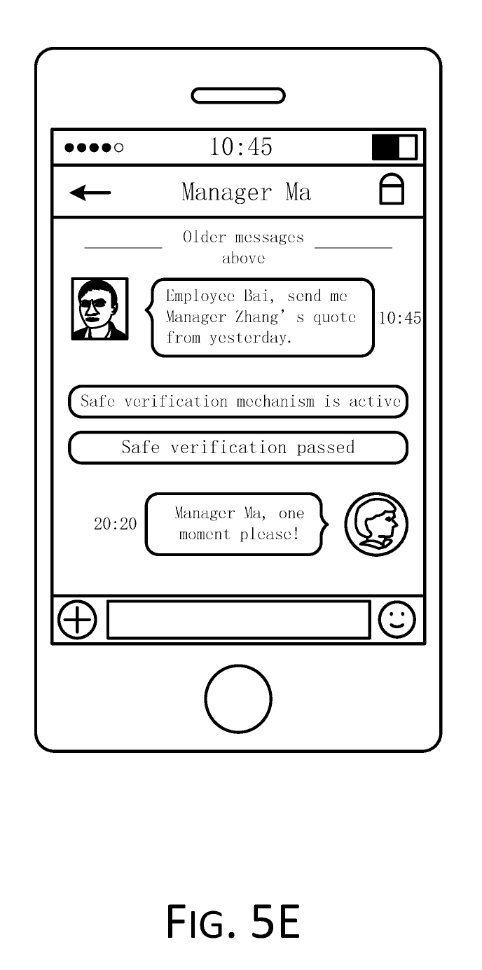

According to the present disclosure, communication information may be any given information in the course of the communication process; for example, communication information may originate from the authentication-responding party, which is user B (device 2) of FIG. 4. Supposing that user A is user “Employee Bai,” and user B is user “Manager Ma,” FIG. 5A illustrates a communication interface of the device 1 utilized by user “Manager Ma”; when device 1 receives the communication information “Employee Bai, send me Manager Zhang's quote from yesterday . . . ” originating from user “Manager Ma,” if “quote” is predetermined as sensitive content, device 1, upon automatically undertaking recognizing and matching the communication information, may proceed to step 406. In particular, sensitive content may vary according to operational habits, interests, application settings, and the like of a user, exhibiting differences correspondingly; a user may also edit sensitive content based on personal situational needs, not to be limited by the present disclosure.

As illustrated by FIG. 5A, at the upper right corner of the interface displayed by device 1 an open “lock” icon is displayed, indicating that identity authentication has not yet started. As illustrated by FIG. 5B, when device 1 initiates identity authentication (namely, initiating a user identity authentication request) to device 2, the “lock” icon at the upper right corner of the interface displayed by device 1 switches from an open state to a closed state, and a prompt may be provided through the text content “Safe verification mechanism is active” as illustrated by FIG. 5B; any other style of prompt may be utilized, not to be limited by the present disclosure.

Communication information may also originate from the authentication-initiating party, such as user A (device 1) of the example embodiment as illustrated by FIG. 4. By way of example, when user “Employee Bai” inputs information into the interface illustrated by FIG. 5A, such as by manual input through the input box at the lower end of the interface, or by voice input and the like, device 1 may undertake recognition and matching upon corresponding input content, thereby determining whether sensitive content is included.

Aside from device 1 detecting content and automatically triggering identity authentication, a user may, based on situational needs, manually trigger identity authentication. For example, in any situation where the user believes it necessary to execute identity authentication, the user may, through clicking on the “lock” icon displayed at the upper right corner of the interface as illustrated by FIG. 5A, effectuate a switch to the “lock” icon in the closed state as illustrated by FIG. 5B, thereby manually activating identity authentication.

In step 408, device 2 retrieves identity authenticating information of user B.

In step 410, device 2 generates response information.

In step 412, device 1 receives response information transmitted by device 2.

In step 414, device 1, based on received response information, executes an identity authentication process.

According to example embodiments, device 2 retrieves identity feature information of user B who is the authentication-responding party, where the identity feature information may include at least one of:

1) Physiological feature information of the communicating counterparty: for example, images, video, and the like containing a predetermined physiological feature of the communicating counterparty, where the predetermined physiological feature may, for example, include a facial feature of the communicating counterparty, such that images containing a predetermined physiological feature of the communicating counterparty may be facial images of the communicating counterparty, videos containing a predetermined physiological feature of the communicating counterparty may be facial video of the communicating counterparty (video containing facial information), and the like; or, physiological feature information may also include fingerprint information, voice clips, retinal information, and the like.

2) Operational habit information of the communicating counterparty: for example, input speed, keystroke pressure, habitual input errors (such as habitually inputting “of” as “fo”) and the like of the communicating counterparty.

All feature information applicable to identity recognition may be applied to technical solutions of the present disclosure, the above examples being provided for illustration only, not to be limited by the present disclosure.

According to an example embodiment, when device 2 generates response information, identity feature information may be directly added to the response information, and device 1 may extract the identity feature information contained in the response information and present the identity feature information to user A who is the present communicating party; as illustrated by FIG. 5C, when identity feature information is a facial image, the facial image may be directly displayed, and after user A who is the present communicating party undertakes recognition, device 1 is notified of the recognition result, such that when the recognition result is “passes authentication” device 1 believes that the communicating counterparty passes identity authentication, i.e., that the current user truly is user B, and when the recognition result is “not the owner” device 1 believes that the communicating counterparty does not pass identity authentication, i.e., that the current user is another user impersonating user B.

Facial images, facial features and such visible physiological feature information, and habitual input errors and such visible operational habit information, may be directly displayed to the present communicating party by device 1; similarly, voice clips and such audibly recognizable physiological feature information may also be directly played to the present communicating party. Fingerprint information, retinal information, and such physiological feature information, and input speed, keystroke pressure, and such operational habit information, are not presentable visibly or audibly; device 1 may compare collected identity feature information and predetermined reference feature information (such as previously retrieved and stored identity feature information of the communicating counterparty), and present comparison data to the present communicating party, for viewing and evaluation.

According to another example embodiment, device 2, when generating response information, may, based on collected identity feature information, authenticate the identity information of user B who is the communicating counterparty, adding the authentication result to the response information. Thereby, device 1 may extract the identity authentication result contained in the response information, and accordingly determine whether the communicating counterparty passes identity authentication, without device 1 itself executing identity authentication.

In particular, device 2 may, according to collected identity feature information, after comparing the identity feature information and predetermined reference feature information, automatically complete identity authentication, avoiding an illicit user utilizing device 2 in impersonating user B.

In step 416, communication between device 1 and device 2 is implemented.

According to example embodiments, when identity authentication operations are executed between the present communicating party and the communicating counterparty, since a presented communication content could pertain to sensitive content, an encrypted communication process may be implemented between the present communicating party and the communicating counterparty, so that even if the communication content is stolen, exposure of sensitive content does not result.

Furthermore:

(1) When device 1 detects sensitive content contained in communication information, user A who is the present communicating party may be notified, and user A determines whether identity authentication needs to be executed. As illustrated in FIG. 5D, device 1 may display prompt information such as “Sensitive content involved, please authenticate counterparty identity” to user A, as well as corresponding options; thereby, when user A selects “authenticate,” device 1 may execute an identity authentication operation to the communicating counterparty, and when user A selects “don't authenticate,” an identity authentication operation to the communicating counterparty is not executed even if sensitive content is contained in the communication information.

(2) According to the above example embodiments, when identity feature information obtained by device 1 is visible information related to the communicating counterparty, device 1 may display the identity feature information at a region related to the communication information originating from the communicating counterparty. As illustrated by FIG. 5E, when identity feature information is a facial image as illustrated by FIG. 5C, the facial image may be a real-time headshot of the communicating counterparty, displayed at a region related to the communication information transmitted by the communicating counterparty, for example, the related region may be to the left of each line of communication information transmitted by user “Manager Ma” in FIG. 5E.

(3) An identity authentication result may have a particular timeliness, i.e., after each time the communicating counterparty is determined to pass identity authentication, a corresponding failure timer may be initialized, that is, the failure timer corresponds to an authenticated time period during which the identity of the communicating counterparty is believed to have passed authentication, so that even if a factor triggering an identity authentication operation occurs during the authenticated time period, such as device 1 detecting communication information containing sensitive information, an identity authentication operation may nevertheless not be triggered. After the authenticated time period, that is, after the failure timer times out, device 1 believes that the communicating counterparty does not pass identity authentication, and thus upon detecting a factor triggering an identity authentication operation such as sensitive content, device 1 may trigger an identity authentication operation.

(4) An identity authentication operation may arise in any given displayed interface, such as the displayed interface illustrated by FIG. 5A; alternately, an identity authentication operation may be limited to, for example, only allowing identity authentication to be executed in “bathhouse,” “bum after reading” (i.e., modes in messaging applications where a party's name and image are obfuscated, and messages sent are automatically deleted after a time period) and such modes of communication where the communicating counterparty may be anonymous; a user may perform configuration based on actual situations, not to be limited by the present disclosure.

2. Server-Based

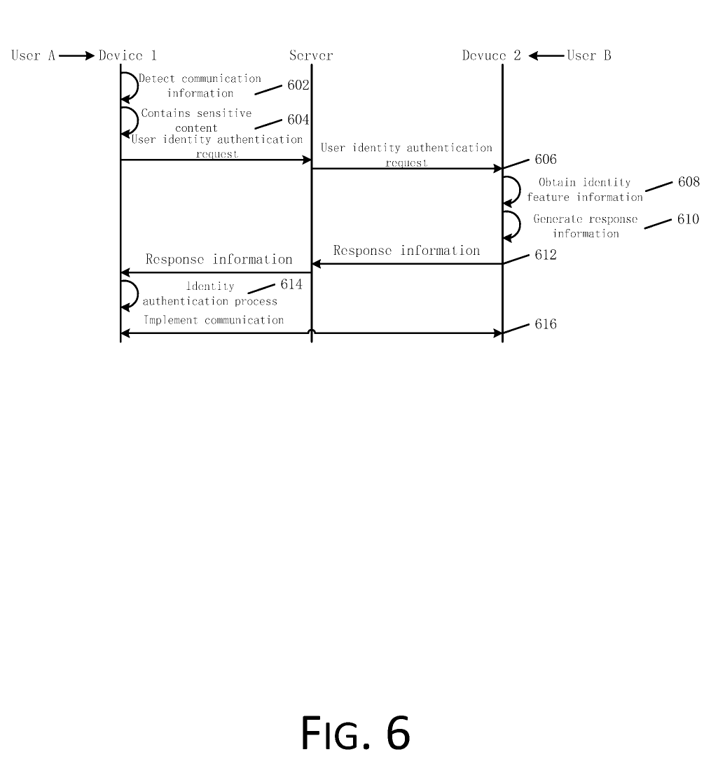

FIG. 4 is a flowchart of another method of communication by adding identity authentication according to an example embodiment provided by the present disclosure. As illustrated by FIG. 6, suppose that user A utilizes device 1, user B utilizes device 2, such that when user A and user B through device 1 and device 2 implement direct communication, a server is needed to perform intermediary functions such as information forwarding and the like, and in the course of the communication process assist in completing identity authentication; for example, when user A initiates authentication and user B responds to authentication, the method may include the following steps:

In step 602, device 1 detects communication information.

In step 604, device 1 determines whether sensitive content is contained in the communication information, and proceeds to step 606 if so contained.

In step 606, device 1, through the server, transmits a user identity authentication request to device 2.

According to example embodiments, device 1 may mark device 2 as the target party of the user identity authentication request, and the server may forward the user identity authentication request issued by device 1 to device 2. The server may apply re-packaging and such processing to the user identity authentication request issued by device 1, but does not alter the content to be delivered.

In step 608, device 2 retrieves identity authenticating information of user B.

In step 610, device 2 generates response information.

In step 612, device 1, through the server, receives response information transmitted by device 2.

In step 614, device 1, based on received response information, executes an identity authentication process.

According to an example embodiment, the server in step 612 may directly forward information transmitted by device 2 to device 1; in particular, for ease of distinction, suppose that information transmitted by device 2 to the server is “return information,” and information transmitted by the server to device 1 is “response information,” so that after the server receives return information, the server may extract content from the return information, and add the content to response information, then transmit the response information to device 1.

The response information may contain identity feature information collected by device 2, or may contain identity authentication results generated by device 2 based on identity feature information, and device 1 may utilize a method similar to the example embodiments illustrated by FIG. 4 to execute an identity authentication operation, details thereof not being repeated herein.

According to another example embodiment, suppose that the return information transmitted by device 2 to the server contains collected identity feature information, so the server may extract the identity feature information and execute identity authentication, then add the resultant identity authentication result to response information, and transmit the response information to device 1; correspondingly, device 1 may, based on an identity authentication result contained in the response information, execute an identity authentication operation, details thereof not being repeated herein. In particular, when the server executes identity authentication using identity feature information collected by device 2, the server may, after comparing the identity feature information to predetermined reference feature information, complete identity authentication itself; or, the server may utilize other methods to implement identity authentication, not to be limited by the present disclosure.

In step 616, communication between device 1 and device 2 is implemented; in particular, the communication process may refer to the above-described step 416, details thereof not being repeated herein.

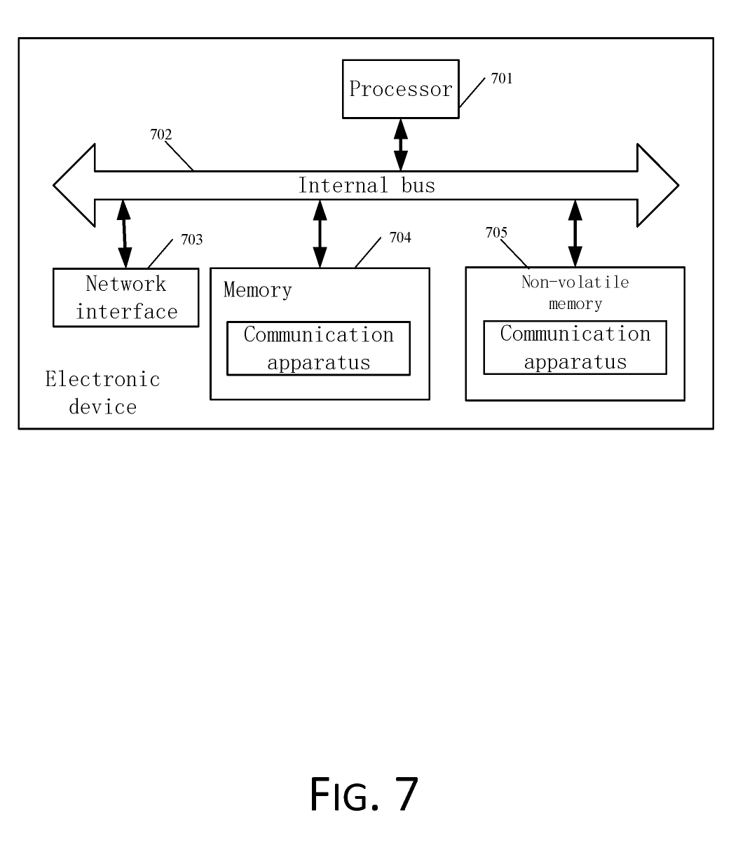

FIG. 7 illustrates a schematic of an electronic device of an authentication-initiating party according to an example embodiment of the present disclosure. Referring to FIG. 7, at the hardware level, the electronic device includes a processor 701, an internal bus 702, a network interface 703, memory 704, and non-volatile memory 705, and may further include hardware required for other services. The processor 701 reads a corresponding computer program from nonvolatile memory 705 to memory 704 and then executes it, establishing a communication apparatus at the logical level. In addition to the software implementation, this application does not exclude other implementations, such as logic devices or combinations of hardware and software, and the like, which is to say that the main execution body of the following process handling is not limited to each logical unit, but may also be a hardware or logic device.

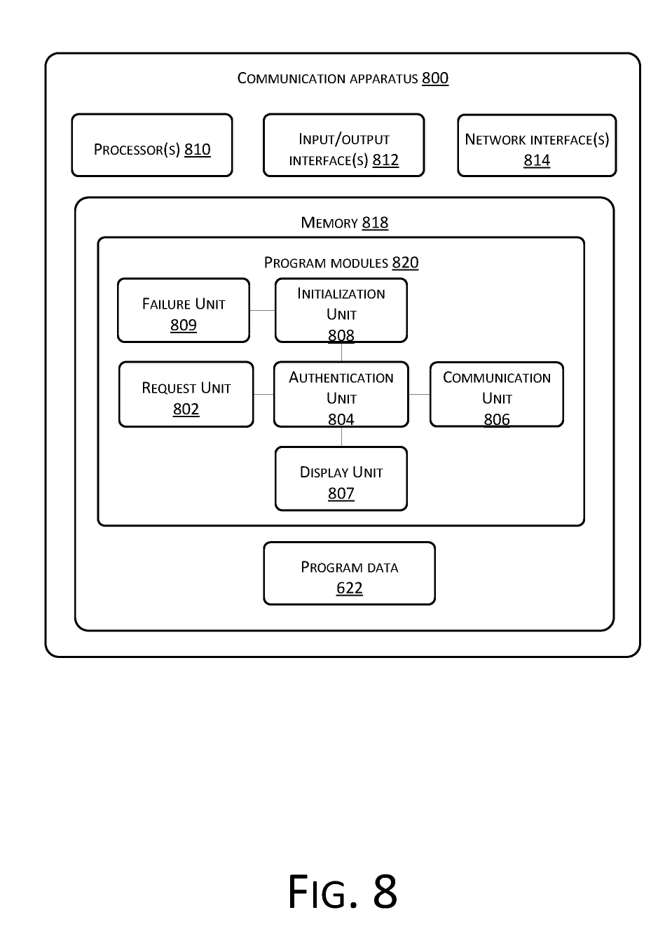

Referring to FIG. 8, according to example embodiments, the communication apparatus 800 may include: a request unit 802, an authentication unit 804, and a communication unit 806. The communication apparatus may further include one or more processors 810, an input/output (I/O) interface 812, a network interface 814, and memory 818. The memory 818 is configured to store an application and data generated during execution of the application. The processor 810 is configured to execute the application stored in the memory to realize the processes shown in FIG. 1. In particular:

The request unit 802 is stored in the memory 818 and executable by the one or more processors 810 to cause a present end device to initiate an identification authentication request to a counterpart end device;

The authentication unit 804 is stored in the memory 818 and executable by the one or more processors 810 to cause the present end device to, based on received response information, determine whether a communicating counterparty passes identity authentication, the response information being transmitted from the counterpart end device to the present end device directly or being generated by a server based on return information originating from the counterpart end device.

The communication unit 806 is stored in the memory 818 and executable by the one or more processors 810 to cause the present end device to, when the communicating counterparty passes identity authentication, complete a communication process between a present communicating party and the communicating counterparty.

Optionally, the request unit 802 is executable by the one or more processors 810 to further:

Cause the present end device to, when the present end device detects predetermined sensitive content contained in communication information, initiate a user identity authentication request upon the counterpart end device.

Optionally, the authentication unit 804 is executable by the one or more processors 810 to further:

Cause the present end device to extract identity feature information contained in the response information and present the identity feature information to the present communicating party;

Cause the present end device to determine, based on a received result of recognition of the identity feature information by the present communicating party, whether the communicating counterparty passes identity authentication.

Optionally, the identity feature information comprises at least one of:

Physiological feature information of the communicating counterparty, and operational habit information of the communicating counterparty.

Optionally, the identity feature information comprises at least one of:

An image containing a predetermined physiological feature of the communicating counterparty, and video containing a predetermined physiological feature of the communicating counterparty.

Optionally, the communication apparatus 800 further comprises:

A display unit 807 stored in the memory 818 and executable by the one or more processors 810 to cause the present end device to, when the identity feature information is visible information related to the communicating counterparty, display the identity feature information at a region related to the communication information originating from the communicating counterparty.

Optionally, the authentication unit 804 is executable by the one or more processors 810 to further:

Cause the present end device to extract an identity authentication result contained in the response information, and accordingly determine whether the communicating counterparty passes identity authentication, the identity authentication result being obtained by the counterpart end device based on acquired identity feature information of the communicating counterparty undergoing authentication, or being obtained by the server based on identity feature information contained in the return information undergoing authentication.

Optionally, the communication unit 806 is executable by the one or more processors 810 to further:

Cause the present end device to implement an encrypted communication process between the present communicating party and the communicating counterparty.

Optionally, the communication apparatus 800 further comprises:

An initialization unit 808 stored in the memory 818 and executable by the one or more processors 810 to, when the communicating counterparty passes identity authentication, initialize a corresponding failure timer;

A failure unit 809 stored in the memory 818 and executable by the one or more processors 810 to, after the failure timer times out, fail the identity authentication result of the communicating counterparty.

An embodiment of the present application further discloses a computer readable storage medium, wherein the computer readable storage medium stores instructions which, when running on a computer, enable the computer to perform the processes shown in FIG. 1.

The memory 818 may include a form of computer readable media such as a volatile memory, a random access memory (RAM) and/or a non-volatile memory, for example, a read-only memory (ROM) or a flash RAM. The memory 818 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 818 may include program modules 820 and program data 822. The program modules 820 may include one or more of the modules as described in above.

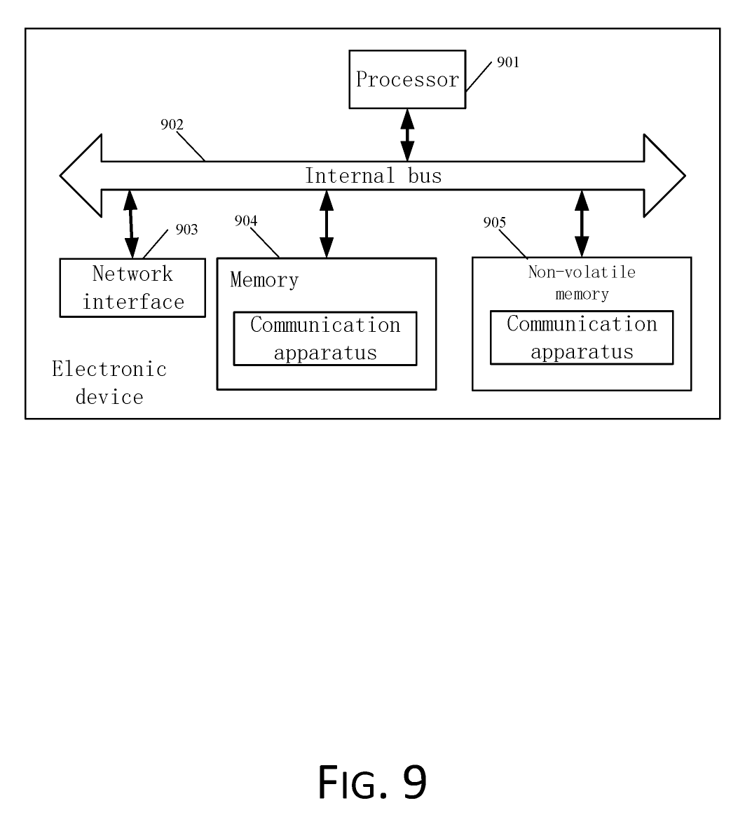

FIG. 9 illustrates a schematic of an electronic device of an authentication-responding party according to an example embodiment of the present disclosure. Referring to FIG. 9, at the hardware level, the electronic device includes a processor 901, an internal bus 902, a network interface 903, memory 904, and non-volatile memory 905, and may further include hardware required for other services. The processor 901 reads a corresponding computer program from nonvolatile memory 905 to memory 904 and then executes it, establishing a communication apparatus at the logical level. In addition to the software implementation, this application does not exclude other implementations, such as logic devices or combinations of hardware and software, and the like, which is to say that the main execution body of the following process handling is not limited to each logical unit, but may also be a hardware or logic device.

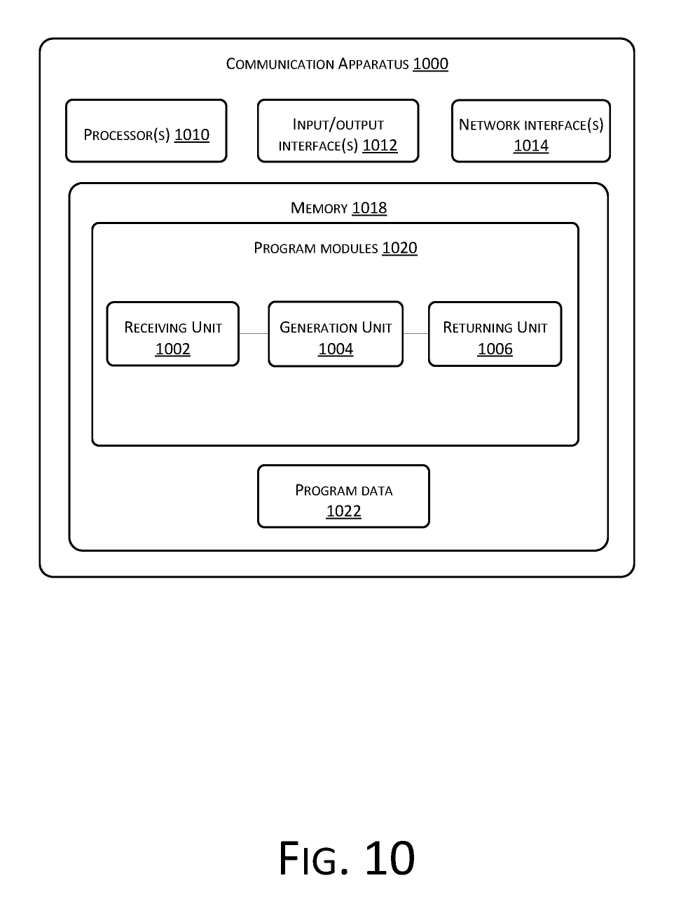

Referring to FIG. 10, according to example embodiments, the communication apparatus 1000 may include: a receiving unit 1002, a generation unit 1004, and a returning unit 1006. The communication apparatus may further include one or more processors 1010, an input/output (I/O) interface 1012, a network interface 1014, and memory 1018. The memory 1018 is configured to store an application and data generated during execution of the application. The processor 1010 is configured to execute the application stored in the memory to realize the processes shown in FIG. 2. In particular:

The receiving unit 1002 is stored in the memory 1018 and executable by the one or more processors 1010 to cause a present end device to receive an identification authentication request initiated by a counterpart end device;

The generation unit 1004 is stored in the memory 1018 and executable by the one or more processors 1010 to cause the present end device to, based on retrieved identity authentication information of the present communicating party, generate response information for the user identity authentication request.

The returning unit 1006 is stored in the memory 1018 and executable by the one or more processors 1010 to cause the present end device to return the response information to the communicating counterparty, and when the communicating counterparty determines that the present communicating party passes identity authentication, complete a communication process between the communicating counterparty and the present communicating party.

Optionally, the generation unit 1004 is executable by the one or more processors 1010 to further:

Cause the present end device to add the identity feature information to the response information; or

Cause the present end device to, based on the identity feature information, authenticate the identity information of the communicating counterparty, and add the authentication result to the response information.

Optionally, the identity feature information comprises at least one of:

Physiological feature information of the communicating counterparty, and operational habit information of the communicating counterparty.

Optionally, the identity feature information comprises at least one of:

An image containing a predetermined physiological feature of the communicating counterparty, and video containing a predetermined physiological feature of the communicating counterparty.

An embodiment of the present application further discloses a computer readable storage medium, wherein the computer readable storage medium stores instructions which, when running on a computer, enable the computer to perform the processes shown in FIG. 2.

The memory 1018 may include a form of computer readable media such as a volatile memory, a random access memory (RAM) and/or a non-volatile memory, for example, a read-only memory (ROM) or a flash RAM. The memory 1018 is an example of a computer readable media.

The computer readable media may include a volatile or non-volatile type, a removable or non-removable media, which may achieve storage of information using any method or technology. The information may include a computer-readable instruction, a data structure, a program module or other data. Examples of computer storage media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In implementations, the memory 1018 may include program modules 1020 and program data 1022. The program modules 1020 may include one or more of the modules as described in above.

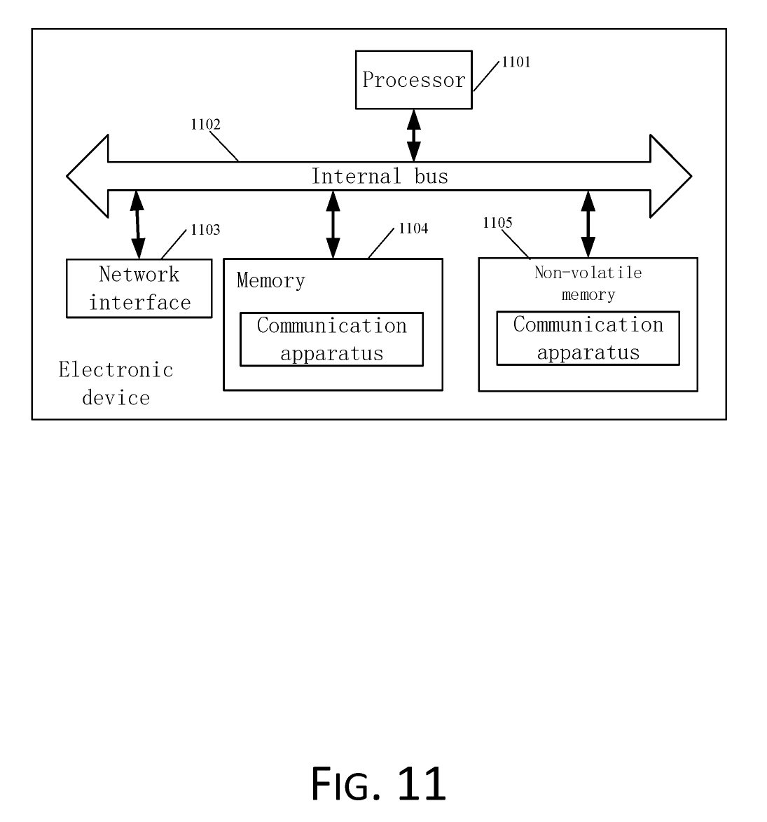

FIG. 11 illustrates a schematic of an electronic device of a server according to an example embodiment of the present disclosure. Referring to FIG. 11, at the hardware level, the electronic device includes a processor 1101, an internal bus 1102, a network interface 1103, memory 1104, and non-volatile memory 1105, and may further include hardware required for other services. The processor 1101 reads a corresponding computer program from nonvolatile memory 1105 to memory 1104 and then executes it, establishing a communication apparatus at the logical level. In addition to the software implementation, this application does not exclude other implementations, such as logic devices or combinations of hardware and software, and the like, which is to say that the main execution body of the following process handling is not limited to each logical unit, but may also be a hardware or logic device.

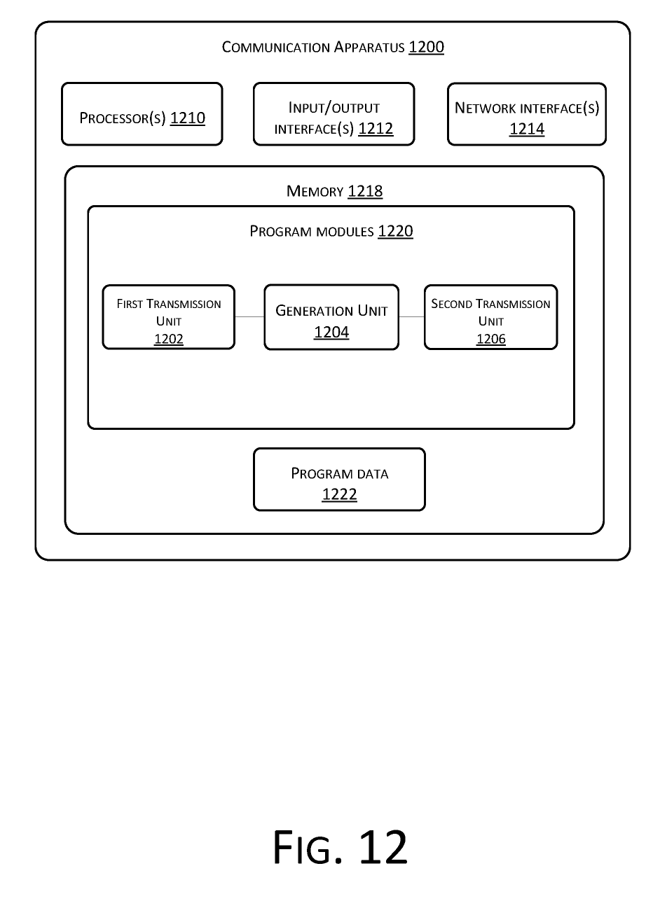

Referring to FIG. 12, according to example embodiments, the communication apparatus 1200 may include: a first transmission unit 1202, a generation unit 1204, and a second transmission unit 1206. The communication apparatus may further include one or more processors 1210, an input/output (I/O) interface 1212, a network interface 1214, and memory 1218. The memory 1218 is configured to store an application and data generated during execution of the application. The processor 1210 is configured to execute the application stored in the memory to realize the processes shown in FIG. 3. In particular:

The first transmission unit 1202 is stored in the memory 1218 and executable by the one or more processors 1210 to cause a server to transmit a user identity authentication request initiated by a first end device to a second end device;

The generation unit 1204 is stored in the memory 1218 and executable by the one or more processors 1210 to cause the server to generate, based on return information of the second end device, response information for the user identity authentication request;

The second transmission unit 1206 is stored in the memory 1218 and executable by the one or more processors 1210 to cause the server to transmit the return information to the first end device, and when the first end device determines that a second communicating party passes identity authentication, completing a communication process between a first communicating party and the second communicating party.

Optionally, the generation unit 1204 is executable by the one or more processors 1210 to further:

Cause the server to add contents of the return information to the response information; or

Cause the server to extract identity feature information of the second communicating party contained in the return information, perform authentication upon the identity feature information, and add the authentication result to the response information.

Optionally, the identity feature information comprises at least one of:

Physiological feature information of the second communicating party, and operational habit information of the second communicating party.

Optionally, the identity feature information comprises at least one of:

An image containing a predetermined physiological feature of the second communicating party, and video containing a predetermined physiological feature of the second communicating party.

An embodiment of the present application further discloses a computer readable storage medium, wherein the computer readable storage medium stores instructions which, when running on a computer, enable the computer to perform the processes shown in FIG. 3.

The memory 1218 may include a form of computer readable media medias described in the foregoing description. In implementations, the memory 1218 may include program modules 1220 and program data 1222. The program modules 1220 may include one or more of the modules as described in above.

The present invention is described by reference to methods, equipment (devices), flowcharts and/or block diagrams of computer program products of embodiments of the invention. It should be appreciated that a computer program instruction may implement each flow and/or block of a flowchart and/or block diagram, or a combination of flows and/or blocks in flowcharts and/or block diagrams. These computer program instructions may be provided to a general-purpose computer, a specialized computer, an embedded processor, or other programmable data processing equipment to produce a machine, where executing an instruction by a processor of a computer or other programmable data processing device produces a device for implementing functions specified in one or more flows of a flowchart and/or one or more blocks of a block diagram.

The computer program instructions may also be stored on a computer or other programmable data processing device, where executing a series of steps on the computer or other programmable data processing device produces a computer-implemented process, where instructions executed on the computer or other programmable data processing device provide steps implementing the functions specified in one or more flows of a flowchart and/or one or more blocks of a block diagram.

In a typical configuration, a computing device includes one or more processors (CPU), an input/output interface, a network interface, and a memory. Memory may include a volatile memory, a random access memory (RAM) and/or a non-volatile memory or the like in a computer-readable medium, for example, a read only memory (ROM) or a flash RAM. The memory is an example of the computer-readable medium. The computer-readable medium includes non-volatile and volatile media as well as movable and non-movable media, and may implement information storage by means of any method or technology. Information may be a computer-readable instruction, a data structure, and a module of a program or other data. An example of the storage medium of a computer includes, but is not limited to, a phase-change memory (PRAM), a static random access memory (SRAM), a dynamic random access memory (DRAM), other types of RAMs, a ROM, an electrically erasable programmable read-only memory (EEPROM), a flash memory or other memory technologies, a compact disc read-only memory (CD-ROM), a digital versatile disc (DVD) or other optical storages, a cassette tape, a magnetic tape/magnetic disk storage or other magnetic storage devices, or any other non-transmission medium, and may be used to store information accessible by the computing device. According to the definition in this text, the computer-readable medium does not include transitory computer-readable media (transitory media) such as a modulated data signal and carrier.

It should also be noted that the terms “include,” “including,” or any other variations thereof are intended to cover non-exclusive inclusions, such that the inclusion of a series of elements in a process, method, article, or apparatus includes not only those elements, but also includes other elements not explicitly listed, or include elements that are inherent to such processes, methods, article, or apparatus. Where no further limitation is given, an element defined by the phrase “includes a...” does not exclude the existence of another identical element in the process, method, article, or apparatus including the element.

The present disclosure may be described in a common context of a computer executable instruction executed by a computer, for example, a program module. Generally, the program module includes a routine, a program, an object, an assembly, a data structure, and the like used for executing a specific task or implementing a specific abstract data type. The present disclosure may also be practiced in distributed computing environments. In these distributed computing environments, a task is executed by using remote processing devices connected through a communications network. In the distributed computing environments, the program module may be located in local and remote computer storage media including a storage device.

Although the present disclosure is described through example embodiments, those of ordinary skill in the art will appreciate that the present disclosure has many variations and changes without departing from the spirit of the present disclosure, and it is expected that the appended claims cover the variations and changes without departing from the spirit of the present disclosure.

The present disclosure may further he understood with clauses as follows.

Clause 1. A method comprising:

initiating, by a present end device to a counterpart end device, a user identity authentication request;

determining, by the present end device based on response information received by the present end device, whether a communicating counterparty passes identity authentication, the response information being transmitted from the counterpart end device to the present end device directly or being generated by a server based on return information originating from the counterpart end device;

when the communicating counterparty passes identity authentication, completing, by the present end device, a communication process between a present communicating party and the communicating counterparty.

Clause 2. The method of clause 1, wherein initiating a user identity authentication request by the present end device to the counterpart end device comprises:

when the present end device detects predetermined sensitive content contained in communication information, initiating, by the present end device, a user identity authentication request upon the counterpart end device.

Clause 3. The method of clause 1, wherein the present end device determining based on response information by the present end device whether a communicating counterparty passes identity authentication comprises:

extracting, by the present end device, identity feature information contained in the response information and presenting the identity feature information to the present communicating party;

determining, by the present end device, based on a received result of recognition of the identity feature information by the present communicating party, whether the communicating counterparty passes identity authentication.

Clause 4. The method of clause 3, wherein the identity feature information comprises at least one of:

physiological feature information of the communicating counterparty; and operational habit information of the communicating counterparty.

Clause 5. The method of clause 3, wherein the identity feature information comprises at least one of:

an image containing a predetermined physiological feature of the communicating counterparty; and

video containing a predetermined physiological feature of the communicating counterparty.

Clause 6. The method of clause 3, further comprising:

when the identity feature information is visible information related to the communicating counterparty, the present end device displaying the identity feature information at a region related to the communication information originating from the communicating counterparty.

Clause 7. The method of clause 1, wherein the present end device determining whether a communicating counterparty passes identity authentication based on response information received by the present end device comprises:

extracting, by the present end device, an identity authentication result contained in the response information, and accordingly determining whether the communicating counterparty passes identity authentication, the identity authentication result being obtained by the counterpart end device based on acquired identity feature information of the communicating counterparty undergoing authentication, or being obtained by the server based on identity feature information contained in the return information undergoing authentication.

Clause 8. The method of clause 1, wherein the present end device completing a communication process between a present communicating party and the communicating counterparty comprises:

the present end device implementing an encrypted communication process between the present communicating party and the communicating counterparty.

Clause 9. The method of clause 1, further comprising:

when the communicating counterparty passes identity authentication, initializing a corresponding failure timer;

after the failure timer times out, failing the identity authentication result of the communicating counterparty.

Clause 10. A communication method, comprising:

transmitting, by a server, a user identity authentication request initiated by a first end device to a second end device;

generating, by the server based on return information of the second end device, response information for the user identity authentication request;

transmitting, by the server, the return information to the first end device, and when the first end device determines that a second communicating party passes identity authentication, completing a communication process between a first communicating party and the second communicating party.

Clause 11. The method of clause 10, wherein the server generating based on return information of the second end device response information for the user identity authentication request comprises one of:

adding, by the server, contents of the return information to the response information; or

extracting, by the server, identity feature information of the second communicating party contained in the return information and presenting the identity feature information to the present communicating party, performing, by the server, authentication upon the identity feature information, and adding, by the server, the authentication result to the response information.

Clause 12. The method of clause 11, wherein the identity feature information comprises at least one of:

physiological feature information of the second communicating party; and

operational habit information of the second communicating party.

Clause 13. The method of clause 11, wherein the identity feature information comprises at least one of:

an image containing a predetermined physiological feature of the second communicating party; and

video containing a predetermined physiological feature of the second communicating party.

Clause 14. A communication apparatus, comprising:

one or more processors;

memory;

a request unit stored in the memory and executable by the one or more processors to cause a present end device to initiate an identification authentication request to a counterpart end device;

an authentication unit stored in the memory and executable by the one or more processors to cause the present end device to, based on received response information, determine whether a communicating counterparty passes identity authentication, the response information being transmitted from the counterpart end device to the present end device directly or being generated by a server based on return information originating from the counterpart end device;

a communication unit stored in the memory and executable by the one or more processors to cause the present end device to, when the communicating counterparty passes identity authentication, complete a communication process between a present communicating party and the communicating counterparty.

Clause 15. The apparatus of clause 14, wherein the request unit is executable by the one or more processors to further:

cause the present end device to, when the present end device detects predetermined sensitive content contained in communication information, initiate a user identity authentication request upon the counterpart end device.

Clause 16. The apparatus of clause 14, wherein the authentication unit is executable by the one or more processors to further:

cause the present end device to extract identity feature information contained in the response information and present the identity feature information to the present communicating party;

cause the present end device to determine, based on a received result of recognition of the identity feature information by the present communicating party, whether the communicating counterparty passes identity authentication.

Clause 17. The apparatus of clause 16, wherein the identity feature information comprises at least one of:

physiological feature information of the communicating counterparty; and

operational habit information of the communicating counterparty.

Clause 18. The apparatus of clause 16, wherein the identity feature information comprises at least one of:

an image containing a predetermined physiological feature of the communicating counterparty; and

video containing a predetermined physiological feature of the communicating counterparty.

Clause 19. The apparatus of clause 16, further comprising:

a display unit stored in the memory and executable by the one or more processors to cause the present end device to, when the identity feature information is visible information related to the communicating counterparty, display the identity feature information at a region related to the communication information originating from the communicating counterparty.

Clause 20. The apparatus of clause 14, the authentication unit executable by the one or more processors to further:

cause the present end device to extract an identity authentication result contained in the response information, and accordingly determine whether the communicating counterparty passes identity authentication, the identity authentication result being obtained by the counterpart end device based on acquired identity feature information of the communicating counterparty undergoing authentication, or being obtained by the server based on identity feature information contained in the return information undergoing authentication.

Clause 21. The apparatus of clause 14, the communication unit executable by the one or more processors to further:

cause the present end device to implement an encrypted communication process between the present communicating party and the communicating counterparty.

Clause 22. The apparatus of clause 14, further comprising:

an initialization unit stored in the memory and executable by the one or more processors to, when the communicating counterparty passes identity authentication, initialize a corresponding failure timer;

a failure unit stored in the memory and executable by the one or more processors to, after the failure timer times out, fail the identity authentication result of the communicating counterparty.

Clause 23. A communication apparatus, comprising:

one or more processors;

memory;

a first transmission unit stored in the memory and executable by the one or more processors to cause the server to transmit a user identity authentication request initiated by a first end device to a second end device;

a generation unit stored in the memory and executable by the one or more processors to cause the server to generate, based on return information of the second end device, response information for the user identity authentication request;

a second transmission unit stored in the memory and executable by the one or more processors to cause the server to transmit the return information to the first end device, and when the first end device determines that a second communicating party passes identity authentication, completing a communication process between a first communicating party and the second communicating party.

Clause 24. The apparatus of clause 23, wherein the generation unit is executable by the one or more processors to further:

cause the server to add contents of the return information to the response information; or

cause the server to extract identity feature information of the second communicating party contained in the return information, perform authentication upon the identity feature information, and add the authentication result to the response information.

Clause 25. The apparatus of clause 24, wherein the identity feature information comprises at least one of:

physiological feature information of the second communicating party; and

operational habit information of the second communicating party.

Clause 26. The apparatus of clause 25, wherein the identity feature information comprises at least one of:

an image containing a predetermined physiological feature of the second communicating party; and

video containing a predetermined physiological feature of the second communicating party.

What is claimed is:

1. A method comprising:
initiating, by a present end device to a counterpart end device, a user identity authentication request;
determining, by the present end device based on response information received by the present end device, whether a communicating counterparty passes identity authentication, the response information being transmitted from the counterpart end device to the present end device directly or being generated by a server based on return information originating from the counterpart end device;
when the communicating counterparty passes identity authentication, completing, by the present end device, a communication process between a present communicating party and the communicating counterparty.

2. The method of claim 1, wherein initiating a user identity authentication request by the present end device to the counterpart end device comprises:
when the present end device detects predetermined sensitive content contained in communication information, initiating, by the present end device, a user identity authentication request upon the counterpart end device.

3. The method of claim 1, wherein the present end device determining based on response information by the present end device whether a communicating counterparty passes identity authentication comprises:
extracting, by the present end device, identity feature information contained in the response information and presenting the identity feature information to the present communicating party;
determining, by the present end device, based on a received result of recognition of the identity feature information by the present communicating party, whether the communicating counterparty passes identity authentication.

4. The method of claim 3, wherein the identity feature information comprises at least one of:
physiological feature information of the communicating counterparty; and
operational habit information of the communicating counterparty.

5. The method of claim 3, wherein the identity feature information comprises at least one of:
an image containing a predetermined physiological feature of the communicating counterparty; and
video containing a predetermined physiological feature of the communicating counterparty.

6. The method of claim 3, further comprising:
when the identity feature information is visible information related to the communicating counterparty, the present end device displaying the identity feature information at a region related to the communication information originating from the communicating counterparty.

7. The method of claim 1, wherein the present end device determining whether a communicating counterparty passes identity authentication based on response information received by the present end device comprises:
extracting, by the present end device, an identity authentication result contained in the response information, and accordingly determining whether the communicating counterparty passes identity authentication, the identity authentication result being obtained by the counterpart end device based on acquired identity feature information of the communicating counterparty undergoing authentication, or being obtained by the server based on identity feature information contained in the return information undergoing authentication.

8. The method of claim 1, wherein the present end device completing a communication process between a present communicating party and the communicating counterparty comprises:
the present end device implementing an encrypted communication process between the present communicating party and the communicating counterparty.

9. The method of claim 1, further comprising:
when the communicating counterparty passes identity authentication, initializing a corresponding failure timer;
after the failure timer times out, failing the identity authentication result of the communicating counterparty.

10. A communication method, comprising:
transmitting, by a server, a user identity authentication request initiated by a first end device to a second end device;
generating, by the server based on return information of the second end device, response information for the user identity authentication request;
transmitting, by the server, the return information to the first end device, and when the first end device determines that a second communicating party passes identity authentication, completing a communication process between a first communicating party and the second communicating party.

11. The method of claim 10, wherein the server generating based on return information of the second end device response information for the user identity authentication request comprises one of:
adding, by the server, contents of the return information to the response information; or
extracting, by the server, identity feature information of the second communicating party contained in the return information and presenting the identity feature information to the present communicating party, performing, by the server, authentication upon the identity feature information, and adding, by the server, the authentication result to the response information.

12. The method of claim 11, wherein the identity feature information comprises at least one of:
physiological feature information of the second communicating party; and
operational habit information of the second communicating party.

13. The method of claim 11, wherein the identity feature information comprises at least one of:
an image containing a predetermined physiological feature of the second communicating party; and
video containing a predetermined physiological feature of the second communicating party.

14. An apparatus, comprising:
one or more processors;
memory;
a request unit stored in the memory and executable by the one or more processors to cause a present end device to initiate an identification authentication request to a counterpart end device;
an authentication unit stored in the memory and executable by the one or more processors to cause the present end device to, based on received response information, determine whether a communicating counterparty passes identity authentication, the response information being transmitted from the counterpart end device to the present end device directly or being generated by a server based on return information originating from the counterpart end device;
a communication unit stored in the memory and executable by the one or more processors to cause the present end device to, when the communicating counterparty passes identity authentication, complete a communication process between a present communicating party and the communicating counterparty.

15. The apparatus of claim 14, wherein the request unit is executable by the one or more processors to further:
cause the present end device to, when the present end device detects predetermined sensitive content contained in communication information, initiate a user identity authentication request upon the counterpart end device.

16. The apparatus of claim 14, wherein the authentication unit is executable by the one or more processors to further:
cause the present end device to extract identity feature information contained in the response information and present the identity feature information to the present communicating party;
cause the present end device to determine, based on a received result of recognition of the identity feature information by the present communicating party, whether the communicating counterparty passes identity authentication.

17. The apparatus of claim 16, further comprising:
a display unit stored in the memory and executable by the one or more processors to cause the present end device to, when the identity feature information is visible information related to the communicating counterparty, display the identity feature information at a region related to the communication information originating from the communicating counterparty.

18. The apparatus of claim 14, the authentication unit executable by the one or more processors to further:
cause the present end device to extract an identity authentication result contained in the response information, and accordingly determine whether the communicating counterparty passes identity authentication, the identity authentication result being obtained by the counterpart end device based on acquired identity feature information of the communicating counterparty undergoing authentication, or being obtained by the server based on identity feature information contained in the return information undergoing authentication.

19. The apparatus of claim 14, the communication unit executable by the one or more processors to further:
cause the present end device to implement an encrypted communication process between the present communicating party and the communicating counterparty.

20. The apparatus of claim 14, further comprising:
an initialization unit stored in the memory and executable by the one or more processors to, when the communicating counterparty passes identity authentication, initialize a corresponding failure timer;
a failure unit stored in the memory and executable by the one or more processors to, after the failure timer times out, fail the identity authentication result of the communicating counterparty.
